(19) United States
(12) Patent Application Publication
(10) Pub. No.: US 2002/0010291 A1
(43) Pub. Date: Jan. 24, 2002

(54) IONIC LIQUIDS AND PROCESSES FOR PRODUCTION OF HIGH MOLECULAR WEIGHT POLYISOOLEFINS

(76) Inventor: VINCE MURPHY, CUPERTINO, CA (US)

Correspondence Address: SYMYX TECHNOLOGIES INC, LEGAL DEPARTMENT, 3100 CENTRAL EXPRESS, SANTA CLARA, CA, 95051

(21) Appl. No.: 09/451,686

(22) Filed: Nov. 30, 1999

Related U.S. Application Data
(60) Provisional application No. 60/110,843, filed on Dec. 4, 1998.

(51) Int. Cl. C08F 4/44

(52) U.S. Cl. 526/133; 526/204; 526/237; 526/239; 526/348.7; 526/189; 502/169; 429/102

(57) ABSTRACT

Ionic liquids function as the initiator or as a co-solvent for the production of very high molecular weight polyisobutylenes, e.g., having a weight-average molecular weight over 100,000. These ionic liquids may be characterized by the general formula A⁺B⁻ where A⁺ represents any stable inorganic or organic cation and B⁻ represents any stable organic or inorganic anion.

The present application claims the benefit of co-pending U.S. Provisional patent application No. 60/110,843 filed Dec. 4, 1998. The entirety of this application is incorporated herein by reference for all purposes.

### FIELD OF THE INVENTION

The present invention relates to ionic liquids that are useful as the catalyst or as a part of the reaction medium for the polymerization of isoolefins, particularly homopolymers or copolymers of isobutylene.

### BACKGROUND OF THE INVENTION

Cationic polymerizations are well known and are described in numerous publications. See, for example G. Odian, Principles of Polymerization (Wiley & Sons, 1991). Cationic polymerization of isoolefins, in particular isobutylene is also well documented. See, for example R. Faust, T. D. Shaffer, Cationic Polymerization (American Chemical Society, 1997). However, there are several disadvantages associated with the known processes, including the use of extremely low temperatures and the need to use polar, volatile solvents such as methyl chloride. There is clearly a need to develop new solvent systems and catalysts, which may be used at higher temperatures.

The environment in which polymerization takes place plays an important role in the catalytic activity of the system. For example, if a catalyst system includes any polar or ionic species, it will typically have different behavior in a non-ionic solvent (such as hexane) versus a highly polar solvent (such as tetrahydrofuran (THF)) versus a solvent having ionic character. A solvent having ionic character is typically one where the anionic and cationic components separate (e.g., a salt).

Ionic liquids are known. Ionic liquids are ionic compositions that are molten at low temperature, which are sometimes referred to as molten salts. See Seddon, “Ionic Liquids for Clean Technology”, J. Chem. Tech. Biotechnol., 68, pp. 351-356 (1997), incorporated herein by reference. Ionic liquids are known to form part of the reaction media for certain types of reactions. For example, Olivier and Chauvin, “Nonaqueous Room-Temperature Ionic Liquids: A New Class of Solvents for Catalytic Organic Reactions”, Chem. Ind. (Dekker) (1996), 68, pp. 249-263, incorporated herein by reference, disclose the use of ionic liquids for dimerization, alkylation, hydrogenation, metathesis, hydroformylation and other reactions. U.S. Pat. No. 5,731,101, incorporated herein by reference, discloses use of ionic liquids for alkylation, arylation and polymerization reactions. U.S. Pat. No. 5,304,615, incorporated herein by reference, discloses use of ionic liquids as the catalyst for polymerization of an olefinic feedstock, which typically contains a mixture of monomers. See also WO 95/21872, WO 98/03454 and WO 95/21806, each of which is incorporated herein by reference. Similarly ionic compounds are known, see for example Kawabata et al. Journal of Antibiotics, vol. 48, no. 9, pp. 1049-1051 (1995).

Despite this knowledge, none of these references has shown the ability to polymerize isobutylenes into a very high molecular weight polymer using an ionic liquid, meaning polyisobutylenes having a weight average molecular weight (Mw) of over 100,000. The difference between very low Mw polyisobutylenes (below about 3,000 Mw), lower Mw polyisobutylenes (about 3,000-10,000 Mw), high Mw polyisobutylenes (between about 10,000-100,000 Mw) and very high Mw polyisobutylenes (above 100,000 Mw) is in the properties that such polymers may possess. Very low Mw polyisobutylenes are typically useful in adhesives, lubricants, motor oil and transmission fluids. Lower Mw polyisobutylenes are useful in sealants and caulking applications. High Mw polyisobutylenes are useful in rubber products or as impact modifiers of thermoplastics. Very high Mw polyisobutylenes possess unique physical and chemical properties, such as low oxygen permeability and mechanical resilience, finding uses in the automobile industry as rubber products.

Also, the syntheses of very high molecular weight polyisobutylenes are not straightforward. For example, it is well known that to obtain very high Mw polyisobutylenes, extremely low temperatures must be employed in the polymerization reaction. Such temperatures are in the region of about −100° C. See G. Odian, Principles of Polymerization (Wiley & Sons, 1991), pp. 396-398, incorporated herein by reference. Thus, the molecular weight of polyisobutylenes produced typically increases as the tempertaure of the polymerization process decreases. However, U.S. Pat. No. 5,304,615 states that when using ionic liquids as the polymerization medium for isobutylene, either alone or with comonomers, “contrary to expectations, the molecular weight of the product does not increase with decreasing temperatures” (col. 4, lines 5-7). Finally, although U.S. Pat. No. 5,304,615 states that polymers of Mw up to 100,000 can be formed (see Example 2), no one has demonstrated, until this invention, the ability to prepare very high Mw polyisobutylenes.

This invention provides a method for straightforward production of very high Mw polyisobutylenes without the need for extremely low temperatures, using isobutylene as the monomer either with a variety of comonomers or alone.

### SUMMARY OF THE INVENTION

In one aspect, this invention uses ionic liquids for the production of very high molecular weight polyisoolefins. These ionic liquids may be characterized by the general formula A⁺B⁻ where A⁺ represents any stable inorganic or organic cation and B⁻ represents any stable organic or inorganic anion. The ionic liquid may itself be used as a catalyst for the polymerization of isoolefins or for the copolymerization of an isoolefin plus additional comonomer. Alternatively, other compounds may be added to the ionic liquid to form a new catalyst composition, which polymerizes an isoolefin or copolymerizes the isoolefin plus additional comonomer. A preferred isoolefin is isobutylene.

In another aspect, this invention uses ionic liquids as a portion of the reaction medium for polymerizing isoolefins into very high molecular weight polyisoolefins. In this aspect, the ionic liquid is part of a two or more phase solvent system, with the other portions of the solvent system comprising non-ionic liquids, such as alkanes (e.g., hexane, heptane), cycloalkanes (e.g., cyclohexane, methylcyclohexane), aromatics (e.g., toluene, benzene), Isopar E®, etc. Preferably in this embodiment, the entire system is agitated to increase surface area between phases and where the system includes all solvents, catalysts, monomers, scavengers, etc. The miscibility of the two or more solvents can be adjusted by changing the components of the ionic liquid, such as by varying the chain length of a hydrocarbon portion of the cation or anion in the ionic liquid.

### DETAILED DESCRIPTION OF THE INVENTION

The phrases “characterized by the formula” or “represented by the formula” are used in the same way that “comprising” is commonly used. The term “independently selected” is used herein to indicate that the R groups, e.g., R¹, R², and R³, can be identical or different (e.g. R¹, R² and R³ may all be substituted alkyls or R¹ and R² may be a substituted alkyl and R³ may be an aryl, etc.). A named R group will generally have the structure that is recognized in the art as corresponding to R groups having that name. For the purposes of illustration, representative R groups as enumerated above are defined herein. These definitions are intended to supplement and illustrate, not preclude, the definitions known to those of skill in the art.

The term “catalyst” is used herein to include all forms of catalysis, including classic initiators, co-initiators, etc. For example, if an organometallic compound has a cationic charge, initiating a cationic polymerization in an ionic liquid, the organometallic will be referred to as a catalyst herein.

The term “hydrocarbyl” is used herein to refer to a radical having only carbon and hydrogen atoms, including, e.g., alkyl and the like.

The term “alkyl” is used herein to refer to a branched or unbranched, saturated or unsaturated, monovalent hydrocarbon radical. When the alkyl group has from 1-6 carbon atoms, it is referred to as a “lower alkyl.” Suitable alkyl radicals include, for example, methyl, ethyl, n-propyl, i-propyl, 2-propenyl (or allyl), n-butyl, t-butyl, i-butyl (or 2-methylpropyl), etc. In particular embodiments, alkyls have between 1 and 200 carbon atoms, between 1 and 50 carbon atoms or between 1 and 20 carbon atoms. “Substituted alkyl” refers to alkyl as just described including one or more groups such as lower alkyl, aryl, acyl, halogen (i.e., alkylhalos, e.g., CF₃), hydroxy, amino, phosphido, alkoxy, alkylamino, acylamino, acyloxy, aryloxy, aryloxyalkyl, mercapto, both saturated and unsaturated cyclic hydrocarbons, heterocycles and the like. These groups may be attached to any carbon of the alkyl moiety.

The term “aryl” is used herein to refer to an aromatic substituent which may be a single aromatic ring or multiple aromatic rings which are fused together, linked covalently, or linked to a common group such as a methylene or ethylene moiety. The common linking group may also be a carbonyl as in benzophenone. The aromatic ring(s) may include substituted or unsubstituted phenyl, naphthyl, biphenyl, diphenylmethyl and benzophenone among others. In particular embodiments, aryls have between 1 and 200 carbon atoms, between 1 and 50 carbon atoms or between 1 and 20 carbon atoms. “Substituted aryl” refers to aryl as just described including one or more groups such as alkyl, acyl, halogen, alkylhalos (e.g., CF₃), hydroxy, amino, phosphido, alkoxy, alkylamino, acylamino, acyloxy, mercapto and both saturated and unsaturated cyclic hydrocarbons which are fused to the aromatic ring(s), linked covalently or linked to a common group such as a methylene or ethylene moiety. The linking group may also be a carbonyl such as in cyclohexyl phenyl ketone. Specific examples of substituted aryl groups include —C₆F₅ and —C₆H₃(CF₃)₂.

The term “acyl” is used to describe a substituted carbonyl substituent, —C(O)J, where J is alkyl or substituted alkyl, aryl or substituted aryl as defined herein.

The term “amino” is used herein to refer to the group —NJJ′, where J and J′ may independently be hydrogen, alkyl, substituted alkyl, aryl, substituted aryl or acyl.

The term “alkoxy” is used herein to refer to the —OJ group, where J is an alkyl, substituted lower alkyl, aryl, substituted aryl, wherein the alkyl, substituted alkyl, aryl, and substituted aryl groups are as described herein. Suitable alkoxy radicals include, for example, methoxy, ethoxy, phenoxy, substituted phenoxy, benzyloxy, phenethyloxy, t-butoxy, etc.

As used herein, the term “phosphino” refers to the group —PJJ′, where J and J′ may independently be hydrogen, alkyl, substituted alkyl, aryl, substituted aryl or acyl.

As used herein, the term “mercapto” defines moieties of the general structure J—S—J′ wherein J and J′ are the same or different and are hydrogen, alkyl, aryl or unsubstituted or substituted heterocyclic as described herein.

The term “saturated cyclic hydrocarbon” denotes groups such as cyclopropyl, cyclobutyl, cyclopentyl, etc. and substituted analogues of these structures.

The term “unsaturated cyclic hydrocarbon” is used to describe a monovalent nonaromatic group with at least one double bond, such as cyclopentene, cyclohexene, etc. and substituted analogues thereof.

The term “heteroaryl” as used herein refers to aromatic rings in which one or more carbon atoms of the aromatic ring(s) are substituted by a heteroatom such as nitrogen, oxygen or sulfur. Heteroaryl refers to structures that may be a single aromatic ring, multiple aromatic ring(s), or one or more aromatic rings coupled to one or more nonaromatic ring(s). In structures having multiple rings, the rings can be fused together, linked covalently, or linked to a common group such as a methylene or ethylene moiety. The common linking group may also be a carbonyl as in phenyl pyridyl ketone. As used herein, rings such as thiophene, pyridine, isoxazole, phthalimide, pyrazole, indole, furan, etc. or benzo-fused analogues of these rings are defined by the term “heteroaryl.”

“Heteroarylalkyl” defines a subset of “alkyl” wherein the heteroaryl group is attached through an alkyl group as defined herein. For example, if R² is a heteroarylalkyl, the alkyl portion will be bonded to the atom from which R² emanates and the heteroaryl portion will be a “substituent” on the alkyl.

“Substituted heteroaryl” refers to heteroaryl as just described wherein the heteroaryl nucleus is substituted with one or more groups such as alkyl, acyl, halogen, alkylhalos (e.g., CF₃), hydroxy, amino, alkoxy, alkylamino, acylamino, acyloxy, mercapto, etc. Thus, substituted analogues of heteroaromatic rings such as thiophene, pyridine, isoxazole, phthalimide, pyrazole, indole, furan, etc. or benzo-fused analogues of these rings are defined by the term “substituted heteroaryl.”

“Substituted heteroarylalkyl” refers to a subset of “substituted alkyls” as described above in which an alkyl group, as defined herein, links the heteroaryl group to the bonding point on the ligand.

The term “heterocyclic” is used herein to describe a monovalent saturated or unsaturated nonaromatic group having a single ring or multiple condensed rings from 1-12 carbon atoms and from 1-4 heteroatoms selected from nitrogen, phosphorous sulfur or oxygen within the ring. Such heterocycles are, for example, tetrahydrofuran, morpholine, piperidine, pyrrolidine, etc.

The term “substituted heterocyclic” as used herein describes a subset of “heterocyclics” wherein the heterocycle nucleus is substituted with one or more functional groups such as alkyl, acyl, halogen, alkylhalos (e.g., CF₃), hydroxy, amino, alkoxy, alkylamino, acylamino, acyloxy, mercapto, etc.

The term “heterocyclicalkyl” defines a subset of “alkyls” wherein an alkyl group, as defined herein, links the heterocyclic group to the bonding point on the molecule.

The term “substituted heterocyclicalkyl” defines a subset of “heterocyclic alkyl” wherein the heterocyclic nucleus is substituted with one or more groups such as alkyl, acyl, halogen, alkylhalos (e.g., CF₃), hydroxy, amino, alkoxy, alkylamino, acylamino, acyloxy, mercapto, etc.

The term “scavenger” is used herein to mean a compound that does not interfere with the reaction, but reacts with impurities or undesired species that may be present in the system. A “scavenger” is intended to refer to a compound that increases catalyst activity presumably by reacting with impurities or undesired species.

Additionally, abbreviations used herein include: Ph=C₆H₅, Me=methyl, Et=ethyl, Prⁱ=isopropyl, TMS=trimethylsilyl, Mes=2,4,6-Me₃C₆H₂, Fc=ferrocene, Bu^{t}=tertiary butyl, DMAT=o-dimethylaminotoluene, DME=dimethoxyethane, and TFA=trifluoroacetate.

The term “polyisobutylenes” is used herein to refer to either homopolymers of isobutylene or copolymers of isobutylene and a suitable comonomer, which include acrylates, methacrylates, acrylonitriles, C₄-C₂₀ butadienes, C₄-C₇ isoolefins, C₄-C₁₂ diolefins, C₄-C₁₂ conjugated diolefins, cationically polymerizable aromatics (such as indene and fulvenes) and styrene (each of which can be substituted or unsubstituted). More specific comonomers included within the definition of polyisobutylenes include those selected from the group consisting of piperylene, 2,3-dimethylbutadiene, 2,4-dimethyl-1,3-pentadiene, cyclopentadiene, methylcyclopentadiene, limonene, 1,3-cyclohexadiene, norbomadiene, isoprene, 1-butene, 2-butene, norbomene and combinations thereof.

The ionic liquids of this invention may be characterized by the general formula A⁺B⁻ where A⁺ is a cationic organic molecule and B⁻ is an anionic organic molecule. In some embodiments, A⁺ can be linked to B⁻ forming a zwitterion. The mole fractions of A⁺ and B⁻ in the ionic liquid may be varied to suit the needs of the polymerization process. See for example J. Chem. Tech. Biotechnol. 68, pp.351-356 (1997), incorporated herein by reference.

Many unsubstituted or substituted heterocyclic ring systems may be converted into a stable cation A⁺ through the process of alkyation or protonation or or acylation or another method known to those of skill in the art. See for example T. L. Gilchrist “Heterocyclic Chemistry” (Wiley & Sons, 1995). Examples of unsubstituted or substituted heterocyclic ring systems that may converted into stable organic cations useful to this invention may be found in the Ring Systems Handbook (publication of the Chemical Abstracts Service 1993 Edition). These include (but are not limited to): imidazoles, pyrazoles, thiazoles, isothiazoles, azathiozoles, oxothiazoles, oxazines, oxazolines, oxazaboroles, dithiozoles, triazoles, selenozoles, oxaphospholes, pyrroles, boroles, furans, thiophens, phospholes, pentazoles, indoles, indolines, oxazoles, isoxazoles, isotriazoles, tetrazoles, benzofurans, dibenzofurans, benzothiophens, dibenzothiophens, thiadiazoles, pyridines, pyrimidines, pyrazines, pyridazines, piperazines, piperidines, morpholones, pyrans, annolines, phthalazines, quinazolines, quinoxalines, quinolines, isoquinolines, thazines, oxazines, azaannulenes and the like.

In addition, acyclic organic systems are also suitable and may be converted into stable organic cations A⁺ in a similar manner. Examples include, but are not limited to amines (including amidines, imines, guanidines and the like), phosphines (including phosphinimines and the like), arsines, stibines, ethers, thioethers, selenoethers and the like.

In some embodiments, A⁺ can be characterized by the general formula:

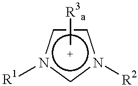

where R¹, R² and R³ are independently selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; and a is 0, 1, 2 or 3 signifying the number of R³ groups attached to a carbon atom of the ring. In a preferred embodiment, R¹ is ethyl and R² is methyl.

In other embodiments, A⁺ can be characterized by the general formula:

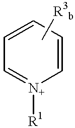

where R¹ and R³ are as defined above and b is 0, 1, 2, 3, 4 or 5 signifying the number of R³ groups attached to a carbon atom of the ring.

In other embodiments, A⁺ can be characterized by the general formula:

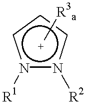

where R¹, R², R³ and a are as defined above.

In yet further embodiments, A⁺ can be characterized by the either of the general formulas: R¹R²R³R⁴N⁺ or R¹R²R³ R⁴P⁺ where each of R¹, R², R³ and R⁴ is independently selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof.

In more specific embodiments, B may be represented by the general formula AlR_{4-z}X_{z}⁻ where R is selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, silyl, boryl, phosphino, amino, thio, seleno, and combinations thereof; X is selected from the group of halogens (e.g., Cl, F, I and Br); and z is 0, 1, 2, 3 or 4. In other embodiments B⁻ may be selected from the group consisting of halogens, BX₄⁻, PF₆⁻, AsF₆⁻, SbF₆⁻, NO₂⁻, NO₃⁻, SO₄²⁻, BR₄⁻ (where B here is boron and R is as defined above), substituted or unsubstituted carboranes, substituted or unsubstituted metallocarboranes, phosphates, phosphites, polyoxometallates, substituted or unsubstituted carboxylates and triflates. B⁻ may also be a noncoordinating anion. See U.S. Pat. No. 5,599,761, incorporated herein by reference.

In an alternative embodiment, an ionic liquid may comprise multiply charged cations or multiply charged anions, or both. For example:

Aⁿ⁺Bⁿ⁻

Aⁿ⁺nB⁻

nA⁺Bⁿ⁻

where n is any positive integer greater than 1.

One example of an ionic liquid using a multiply charged ion is one that uses an imidazolium cation that may be represented by the following general formula:

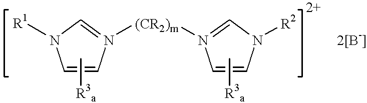

where R, R¹, R², R³ and a are as defined above and m is an integer from 1-50. This example is depicted with an alkyl chain connecting the two-imidazolium moieties, but other connecting chains may also be used, such as substituted alkyls, substituted aryls and the like. Ionic liquids containing other multiply charged systems can also be used, including multiply charged cations prepared from the other unsubstituted or substituted heterocyclic ring systems or acyclic systems described above. Ionic liquids containing multiply charged ions may be mixed with ionic liquids containing singly charged ions to form useful catalyst combinations.

The ionic liquid of this invention may be combined with reagents that may catalyze cationic polymerizations, such as, but not limited to BR_{3-y}X_{y}, AlR_{3-y}X_{y}, alkylaluminoxanes, GaR_{3-y}X_{y}, InR_{3-y}X_{y}, TiR_{4-z}X_{z}, In(triflate)₃, Ge[NR₂]₂, SnR_{4-z}X_{z}, VCl₃, VCl₄, VOCl₃, VOCl₂, Sc(triflate)₃, Yb[NR₂]₃, Ti(OPrⁱ)₄, CpTiMe₃, Cp₂TiR₂, Cp₂ZrR₂, Cp₂HfR₂, TiCl₃, ZrCl₃, HfCl₃, ZrCl₄, HfCl₄, Ti[(NR₂)_{4-z}R_{z}], Zr[(NR₂)_{4-z}R_{z}], Hf[(NR₂)_{4-z}R_{z}], Zr[(NR₂)_{4-z}X_{z}], Hf[(NR₂)_{4-z}X_{z}], Ti[(NR₂)_{4-z}X_{z}], La[NR₂]₂, Er[NR₂]₂, ThCl₄, ThOCl₂, UCl₄, UCl₅, Cp₃U, NbCl₅, TaCl₅, CrCl₂, Cr(TFA)₂, CrCl₃, Cr(TFA)₃, CrOCl₂, CrO₂Cl₂, CrO₃, Cp₂Cr, MoCl₃, MoCl₄, MoCl₅, WCl₃, WCl₄, FeCl₂, Fe(TFA)₂, FeCl₃, Fe(TFA)₃, Co(TFA)₂, Co(TFA)₃, Mn(TFA)₂, Ni(TFA)₂, Pd(TFA)₂, V(TFA)₃, V(TFA)₂, Cu(TFA), Ag(TFA), SbX₅, PX₅, PX₃, POX₃, Cp₂AlR, HX, RX, water, alcohols, triflic acids, substituted or unsubstituted carboxylic acids, acylium ions, substituted alkyls, substituted aryls, [Ph₃C][BR₄], [R₃NH][BR₄], [R₂OH][BR₄], [Ph₃C][BX₄], [Ph₃C][PF₆], [Ph₃C][SbF₆], [Ph₃C][AsF₆], NaBR₄, LiBR₄, KBR₄, AgBX₄, AgBR₄, AgPF₆, AgSbF₆, AgAsF₆, AgNO₃, PbBX₄, PbBR₄, PbPF₆, PbSbF₆, PbAsF₆, PbNO₃, TlBR₄, TlPF₆, TlBX₄, TlSbF₆, TlAsF₆, TiNO₃ and any combinations thereof. In the above list, R is defined as above; y is a number 0, 1, 2 or 3; z is a number 0, 1, 2, 3 or 4; Cp is an unsubstituted or substituted cyclopentadienyl ring, substituted or unsubstituted indenyl, substituted or unsubstituted fluorenyl and the like such as bridging versions of cyclopentadienyl, indenyl and fluorenyl complexes; X is a halogen, such as Cl, Br, I or F. Other catalysts known to those skilled in the art may also be suitable.

In another alternative embodiment, the ionic liquid of this invention may contain a functional group that can act as a catalyst or scavenger or that can bind to a catalyst or scavenger. For example, the functional group may be attached directly to the cationic portion of the ionic liquid, such as is represented by the following general formula:

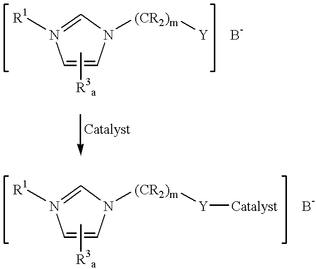

where R, R¹, R³, a and m are as defined above, and Y is any functional group capable of binding the catalyst or scavenger to a component of the ionic liquid. Alternatively, the catalyst or scavenger may be joined to the anion (B⁻) in a similar manner. In the example above an alkyl chain is used to tether the catalyst to the organic cation. Other tethers are known and may be used in this embodiment, such as those that are discussed in U.S. patent application Ser. No. 09/025,841, filed Feb. 19, 1998, incorporated herein by reference. In this embodiment other stable ionic liquids can also be used, including ionic liquids containing multiply charged systems and ionic liquids comprising cations prepared from the other unsubstituted or substituted heterocyclic ring systems or acyclic systems described above. Additionally, functionalized ionic liquids from this embodiment may be combined with non-functionalized ionic liquids (containing singly or multiply charged ions) to form useful catalyst compositions. Ionic liquids from this embodiment may be combined with a catalyst or scavenger or any combination thereof to form a useful catalyst composition. An example of an ionic liquid of this embodiment is:

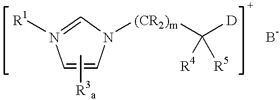

where R, R¹, R³ a and m are as defined above; and R⁴ and R⁵ are defined as R¹ is defined above and D may be any halogen, SCN, CN, OH, OR, OCOR, COOR, O₂SR. This ionic liquid may be combined with a catalyst (and/or optionally scavengers) such as those listed above to form useful catalyst compositions capable of preparing very high molecular weight polyisobutylenes.

The ionic liquids of this invention may be made by methods known to those of skill in the art. See for example, U.S. Pat. No. 5,731,101 and WO 95/21871, both of which are incorporated herein by reference.

The ionic liquids of this invention can be catalysts alone, or may be combined with other compounds to form new catalytic compositions. Organometallic complexes may be added to the ionic liquids, with such complexes being any of those disclosed in commonly owned U.S. patent application Ser. No. 08/898,715, filed Jul. 22, 1997, incorporated herein by reference. The catalysts useful with the ionic liquids are those that initiate a cationic polymerization reaction, including those listed above. See also WO 95/29940, incorporated herein by reference.

The presence of the ionic liquid will have an effect on the polarity and polarizability of the polymerization mixture. Thus, depending on the type of process employed, the structure, yield, selectivity, molecular weight, etc. of the polymer product formed can vary. Since the ionic liquid can solubilize compounds that are ordinarily insoluble in organic solvents (e.g., metal complexes), the products can be readily separated from the ionic liquid, for example by decanting. Thus, this invention provides an easy method for removing product polymers from unwanted catalyst and avoiding additional ashing procedures for the removal of catalysts from polymer products. Therefore, this invention anticipates that novel polymers, copolymers or interpolymers may be formed as a result of the processes of this invention, including polymers having unique physical and melt flow properties. Such polymers can be employed alone or with other polymers in a blend to form products that may be molded, cast, extruded or spun. When desired, the polyisoolefins have a weight average molecular weight of greater than 100,000, preferably greater than 250,000, more preferably greater than 400,000 and most preferably greater than 500,000. In some embodiments, the polyisobutylenes of this invention have a weight average molecular weight of greater than 100,000, preferably greater than 250,000, more preferably greater than 400,000 and most preferably greater than 500,000.

Polymerization can be carried out in a cationic process or in the Ziegler-Natta or Kaminsky-Sinn methodology, including temperatures of from −100° C. to 400° C. and pressures from atmospheric to 3000 atmospheres. Thus, the ionic liquids may serve only as the solvent for an organometallic compound or complex, which acts as the catalyst. There are numerous examples of catalytic organometallic complexes, such as mono-cyclopentadienyl or bis-cyclopentadienyl complexes. The organometallic compounds may be active catalysts or may be combined with an activator. When an activator or activating technique is used, those of skill in the art may use alumoxanes, strong Lewis acids, compatible noninterfering activators and combinations of the foregoing. See U.S. Pat. Nos. 5,599,761, 5,616,664, 5,453,410, 5,153,157 and 5,064,802. Suspension, solution, slurry, gas phase or high-pressure polymerization processes may be employed with the catalysts and compounds of this invention. Such processes can be run in a batch, semi-batch or continuous mode. Examples of such processes are well known in the art. A support for the catalyst may be employed, which may be alumina, silica or a polymers support. Methods for the preparation of supported catalysts are known in the art. Slurry, suspension, solution and high-pressure processes use a suitable solvent as known to those skilled in the art. Cationic polymerization processes are well known to those of skill in the art and can be used herein.

In another embodiment, the ionic liquids of this invention form a portion of the reaction medium by mixing the ionic liquid with one or more co-solvents. Typically, this means that a two-phase solvent mixture is used for the polymerization reaction. Vigorous mixing is typically employed in this embodiment, but it is possible that proper selection of the ionic liquid and co-solvent(s) will mean that such mixing is not required. For example, the miscibility of the ionic liquid with the one or more co-solvents may result in a solvent system that does not appear to be two phase solvent. The miscibility of the ionic liquid with the co-solvent(s) can be adjusted by changing R, R¹, R² or R³ in the above formulas for the ionic liquids to be more compatible with the co-solvent. For example if R is a long chain alkane, the ionic liquid will be more miscible with a hexane co-solvent. A long chain alkane is considered to be a C₁₀-C₁₀₀ alkyl, for example. Co-solvents can be selected from the group consisting of alkanes, substituted alkanes, cycloalkanes, substituted cycloalkanes, aromatics and substituted aromatics. The use of a mixed solvent system (i.e., ionic liquid and co-solvent) may increase the solubility of certain organometallic complexes. See, Chauvin et al., Ind. Eng. Chem. Res., Vol 34, No. 4, pp. 1149-1155 (1995).

Other Reactions useful to this invention include but are not limited to certain other organic transformations, such as cross-coupling reactions (e.g., Suzuki, Heck, aminations, Negishi, Meyers, Stille etc.), Friedel Crafts, dimerization, oligomerization and polymerization reactions (e.g., Ziegler-Natta catalysts and other single-site coordination catalysts such as metallocenes may be used in the presence of an ionic liquids), hydrogenations, hydrosilylations, hyrdoformylations, oxidations, epoxidations, reductions and the like. Other transformations will be known to those skilled in the art.

### EXAMPLES

Starting materials were purchased from commercial sources and were passed through water and oxygen removal columns prior to use, as necessary. The polymerization examples were performed in cooled 1 ml glass vials with magnetic stirring. In a typical experiment, the ionic liquid was first dispensed into the vial and allowed to cool. If required, additional catalysts were added at this point and the mixture was allow to equilibrate at the chosen temperature. With stirring, the olefin was then added with or without additional solvent. The polymerizations were run for 1 hour before 30 μl ethanol was added as a quenching agent. Yields were determined gravimetrically and molecular weights were determined using GPC calibrated with polyisobutylene standards. Polymerization examples were performed in an inert atmosphere glove box, using either nitrogen or argon as the inert atmosphere. Synthesis examples were performed using standard Schlenk techniques or an inert atmosphere glove box, again with either nitrogen or argon as the inert atmosphere.

### Example 1

The following example represents the case where the ionic liquid was used as a catalyst for the polymerization of isobutylene. The ionic liquid chosen for this library was 1 -methyl-3 -ethylimidazolium aluminum tetrachloride. The following table gives the polymerization conditions, coversion data and molecular weights obtained

| | Volume | Solvent | | | | |
|---|---|---|---|---|---|---|
| | of Ionic | Type and | Amount of | | | |
| | Liquid | Amount | Isobutylene | Temp | Yield | Mw |
| Example | (μl) | (μl) | (μl) | (° C.) | (%) | (×10³) |
| 1.1 | 10 | None | 483 | −40 | 38 | 526 |
| 1.2 | 10 | None | 483 | −30 | 33 | 302 |
| 1.3 | 10 | None | 483 | −20 | 45 | 128 |

### Example 2

The following example represents the case where a catalyst was added to an ionic liquid to produce a new catalyst composition for the polymerization of isobutylene. The catalyst chosen for this library was ethylaluminumdichloride dispensed as a 1 M solution in hexane. The polymerizations were all performed in hexane at −30° C. The ionic liquid chosen for this library was 1 -methyl-3-ethylimidazolium aluminum tetrachloride.

| | Volume | Solvent | | Amount | | |
|---|---|---|---|---|---|---|
| | of Ionic | Type and | Amount of | of | | |
| | Liquid | Amount | Isobutylene | EtAlCl₂ | Yield | Mw |
| Example | (μl) | (μl) | (μl) | (μl) | (%) | (×10³) |
| 2.1 | 50 | hexane | 25 | 11 | 100 | 276 |
| | | (321) | | | | |
| 2.2 | 50 | hexane | 25 | 23 | 100 | 235 |
| | | (310) | | | | |
| 2.3 | 50 | hexane | 25 | 34 | 100 | 186 |
| | | (298) | | | | |

### Example 3

This example demonstrates the synthesis of a multiply charged imidazolium compound useful for the preparation of ionic liquids containing the di-cation components.

Part A: Synthesis of [1,4-Bis-(3-Methylimidazolium)butane]²⁺Br₂⁻.

A mixture of 16.7 ml (210 mmol) 3-Methylimidizole and 11.9 ml (100 mmol) 1,4-dibromobutane was stirred at room temperature for 1 hour after which time the resultant viscous brown oil was heated to 100 C for 12 hours. The volatiles were removed under vacuum at 100 C to produce a brown residue. The product, 1,4-Bis-(3-Methylimidazolium)butanedibromide was collected as a brown solid upon washing with a 1:1 mixture of acetonitrile/hexane and characterized by ¹H NMR and elemental analysis.

Part B: Synthesis of [1,4-Bis-(3-Methylimidazolium)butane]2+[bromotrichloroaluminate]₂⁻

A 1:3.7 mixture of 1,4-Bis-(3-Methylimidazolium)butanedibromide and AlCl₃ was stirred in methylene chloride for 1 hour leading to the formation of a phase separated brown liquid, which was isolated by the removal of the solvent.

### Example 4

Preparation of 1-Ethyl-3-methyl-imidazolium chloro(tris-pentafluorophenyl)borate

A 1:1 mixture of 1-Ethyl-3-methyl-imidazolium chloride and tris(pentafluorophenyl)boron in methylene chloride was stirred for 1 hour whereupon the solvent was removed to produce a clear oil.

It is to be understood that the above description is intended to be illustrative and not restrictive. Many embodiments will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and reference, including patent application and publication, are incorporated herein by reference for all purposes.

What is claimed is:

1. A process for forming polyisobutylenes, comprising employing an ionic liquid in said process and said process resulting in a polyisobutylene having a weight average molecular weight greater than 100,000.

2. The process of claim 1 wherein said ionic liquid may be characterized by the general formula A⁺B⁻ where A⁺ represents any stable inorganic or organic cation and B⁻ represents any stable organic or inorganic anion.

3. The process of claim 2 wherein A⁺ is a stable cationic molecule that is created by alkylation of a compound selected from the group consisting of imidazoles, pyrazoles, thiazoles, isothiazoles, azathiozoles, oxothiazoles, oxazines, oxazolines, oxazaboroles, dithiozoles, triazoles, selenozoles, oxaphospholes, pyrroles, boroles, furans, thiophens, phospholes, pentazoles, indoles, indolines, oxazoles, isoxazoles, isotriazoles, tetrazoles, benzofurans, dibenzofurans, benzothiophens, dibenzothiophens, thiadiazoles, pyridines, pyrimidines, pyrazines, pyridazines, piperazines, piperidines, morpholones, pyrans, annolines, phthalazines, quinazolines and quinoxalines.

4. The process of claim 2 wherein A⁺ is a stable cationic molecule that is created by protonation or acylation of a compound selected from the group consisting of imidazoles, pyrazoles, thiazoles, isothiazoles, azathiozoles, oxothiazoles, oxazines, oxazolines, oxazaboroles, dithiozoles, triazoles, selenozoles, oxaphospholes, pyrroles, boroles, furans, thiophens, phospholes, pentazoles, indoles, indolines, oxazoles, isoxazoles, isotriazoles, tetrazoles, benzofurans, dibenzofurans, benzothiophens, dibenzothiophens, thiadiazoles, pyridines, pyrimidines, pyrazines, pyridazines, piperazines, piperidines, morpholones, pyrans, annolines, phthalazines, quinazolines, quinolines, isoquinolines, thazines, oxazines, azaannulenes and quinoxalines.

5. The process of claim 2 wherein A⁺ can be characterized by the general formula: 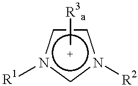
where R¹, R² and R³ are independently selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; and a is 0, 1, 2 or 3 signifying the number of R³ groups attached to a carbon atom of the ring.

6. The process of claim 2 wherein A⁺ can be characterized by the general formula: 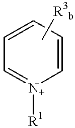
where R¹ and R³ are independently selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; and b is 0, 1, 2, 3, 4 or 5 signifying the number of R³ groups attached to a carbon atom of the ring.

7. The process of claim 2 wherein A⁺ can be characterized by the general formula: 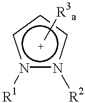
where R, R² and R³ are independently selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; and a is 0, 1, 2, or 3 signifying the number of R³ groups attached to a carbon atom of the ring.

8. The process of claim 2 where A⁺ can be characterized by the either of the general formulas: R¹R²R³R⁴N⁺ or R¹R²R³R⁴P⁺ where each of R¹, R², R³ and R⁴ is independently selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof.

9. The process of claim 2 where A⁺ is an acyclic organic compound capable of being converted into a stable organic cation, and the acyclic compound is selected from the group consisting of amines, phosphines, arsines, stibines, ethers, thioethers and selenoethers.

10. The process of claim 2 wherein B⁻ is represented by the general formula AlR_{4-z}X_{z}⁻ where R is selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; X is selected from the group of halogens; and z is 0, 1, 2, 3 or 4.

11. The process of claim 2 wherein B⁻ may be selected from the group consisting of halogens, BX₄⁻, PF₆⁻, AsF₆⁻, SbF₆⁻, NO₂⁻, NO₃⁻, SO₄²⁻, BR₄⁻, substituted or unsubstituted carboranes, substituted or unsubstituted metallocarboranes, phosphates, phosphites, polyoxometallates, substituted or unsubstituted carboxylates, triflates and noncoordinating anions; and wherein R is selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof.

12. The process of claim 1 wherein said ionic liquid may be characterized by one of the general formulas Aⁿ⁺Bⁿ⁻, Aⁿ⁺ nB⁻ or nA⁺Bⁿ⁻ where n is any positive integer greater than 1 and where A represents any stable inorganic or organic cation and B represents any stable organic or inorganic anion.

13. The process of claim 12, wherein Aⁿ⁺ may be represented by the following general formula: 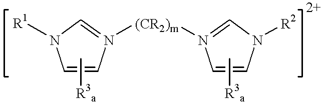
where n is 2; R, R¹, R² and R³ are independently selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; a is 0, 1, 2, or 3 signifying the number of R³ groups attached to a carbon atom of the ring; and m is an integer from 1-50.

14. The process of claim 13 wherein the CR₂ is replaced with a compound selected from the group consisting of substituted alkyls and substituted aryl.

15. The process of claim 12, additionally comprising a second ionic liquid characterized by the general formula A⁺B⁻ where A⁺ represents any stable inorganic or organic cation and B⁻ represents any stable organic or inorganic anion.

16. The process of claim 1, additionally comprising a reagent that may initiate cationic polymerizations.

17. The process of claim 16 wherein said reagent is selected from the group consisting of BR_{3-y}X_{y}, AlR_{3-y}X_{y}, alkylaluminoxanes, GaR_{3-y}X_{y}, InR_{3-y}X_{y}, TiR_{4-z}X_{z}, In(triflate)₃, Ge[NR₂]₂, SnR_{4-z}X_{Z}, VCl₃, VCl₄, VOCl₃, VOCl₂, Sc(triflate)₃, Yb[NR2]₃, Ti(OPrⁱ)₄, CpTiMe₃, Cp₂TiR₂, Cp₂ZrR₂, Cp₂HfR₂, TiCl₃, ZrCl₃, HfCl₃, ZrCl₄, HfCl₄, Ti[(NR₂)_{4-z}R_{z}], Zr[(NR₂)_{4-z}R_{z}], Hf[(NR₂)_{4-z}R_{z}], Zr[(NR₂)_{4-z}X_{z}], Hf[(NR₂)_{4-z}X_{z}], Ti[(NR₂)_{4-z}X_{z}], La[NR₂]₂, Er[NR₂]₂, ThCl₄, ThOCl₂, UCl₄, UCl₅, Cp₃U, NbCl₅, TaCl₅, CrCl₂, Cr(TFA)₂, CrCl₃, Cr(TFA)₃, CrOCl₂, CrO₂Cl₂, CrO₃, Cp₂Cr, MoCl₃, MoCl₄, MoCl₅, WCl₃, WCl₄, FeCl₂, Fe(TFA)₂, FeCl₃, Fe(TFA)₃, Co(TFA)₂, Co(TFA)₃, Mn(TFA)₂, Ni(TFA)₂, Pd(TFA)₂, V(TFA)₃, V(TFA)₂, Cu(TFA), Ag(TFA), SbX₅, PX₅, PX₃, POX₃, Cp₂AlR, HX, RX, water, alcohols, triflic acids, substituted or unsubstituted carboxylic acids, acylium ions, substituted alkyls, substituted aryls, [Ph₃C][BR₄], [R₃NH][BR4], [R₂OH][BR₄], [Ph₃C][BX₄], [Ph₃C][PF₆], [Ph₃C][SbF₆], [Ph₃C][AsF₆], NaBR₄, LiBR₄, KBR₄, AgBX₄, AgBR₄, AgPF₆, AgSbF₆, AgAsF₆, AgNO₃, PbBX₄, PbBR₄, PbPF₆, PbSbF₆, PbAsF₆, PbNO₃, TlBR₄, TlPF₆, TlBX₄, TlSbF₆, TlAsF₆, TlNO₃ and combinations thereof; where R is selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; y is a number 0, 1, 2 or 3; z is a number 0, 1, 2, 3 or 4; Cp is an unsubstituted or substituted cyclopentadienyl ring, substituted or unsubstituted indenyl, substituted or unsubstituted fluorenyl, including bridging versions thereof; and X is a halogen.

18. The process of claim 2, wherein the ionic liquid contains a group that can act as a catalyst or scavenger and said functional group is covalently bonded to either A⁺ or B⁻.

19. The process of claim 18, wherein said functional group is attached directly to the cationic portion of the ionic liquid, so that A⁺ may represented by the following general formula: 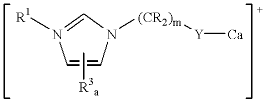
where each R, R¹ and R³ are independently selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; a is 0, 1, 2, or 3 signifying the number of R³ groups attached to a carbon atom of the ring; m is an integer from 1-50; Y is any functional group capable of binding the catalyst, initiator or scavenger; and Ca is the catalyst or scavenger.

20. The process of claim 18, wherein said group is covalently bonded to B⁻.

21. The process of claim 2, wherein said ionic liquid may be characterized by the general formula: 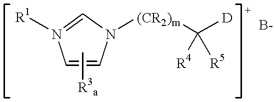
where R, R¹, R³, R⁴ and R⁵ are are independently selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, silyl, boryl, phosphino, amino, thio, seleno, and combinations thereof; a is 0, 1, 2, or 3 signifying the number of R³ groups attached to a carbon atom of the ring; m is an integer from 1-50; and D is selected from the group consisting of halogen, SCN, CN, OH, OR, OCOR, COOR, O₂SR.

22. The process of claim 1, wherein the polyisobutylene has a weight average molecular weight of greater than 250,000.

23. The process of claim 1, wherein the polyisobutylene has a weight average molecular weight of greater than 500,000.

24. An ionic liquid characterized by the general formula A⁺B⁻ where A⁺ represents any stable inorganic or organic cation and B⁻ represents any stable organic or inorganic anion; and wherein A⁺ is a stable cationic molecule that is created by alkylation of a compound selected from the group consisting of imidazoles, pyrazoles, thiazoles, isothiazoles, azathiozoles, oxothiazoles, oxazines, oxazolines, oxazaboroles, dithiozoles, triazoles, selenozoles, oxaphospholes, pyrroles, boroles, furans, thiophens, phospholes, pentazoles, indoles, indolines, oxazoles, isoxazoles, isotriazoles, tetrazoles, benzofurans, dibenzofurans, benzothiophens, dibenzothiophens, thiadiazoles, pyridines, pyrimidines, pyrazines, pyridazines, piperazines, piperidines, morpholones, pyrans, annolines, phthalazines, quinazolines, quinolines, isoquinolines, thazines, oxazines, azaannulenes and quinoxalines.

25. An ionic liquid characterized by the general formula A⁺B⁻ where A⁺ represents any stable inorganic or organic cation and B⁻ represents any stable organic or inorganic anion; and wherein A⁺ is a stable cationic molecule that is created by acylation of a compound selected from the group consisting of imidazoles, pyrazoles, thiazoles, isothiazoles, azathiozoles, oxothiazoles, oxazines, oxazolines, oxazaboroles, dithiozoles, triazoles, selenozoles, oxaphospholes, pyrroles, boroles, furans, thiophens, phospholes, pentazoles, indoles, indolines, oxazoles, isoxazoles, isotriazoles, tetrazoles, benzofurans, dibenzofurans, benzothiophens, dibenzothiophens, thiadiazoles, pyridines, pyrimidines, pyrazines, pyridazines, piperazines, piperidines, morpholones, pyrans, annolines, phthalazines, quinazolines, quinolines, isoquinolines, thazines, oxazines, azaannulenes and quinoxalines.

26. An ionic liquid characterized by the general formula A⁺B⁻ where A⁺ represents any stable inorganic or organic cation and B⁻ represents any stable organic or inorganic anion; and wherein A⁺ is a stable cationic molecule that is created by protonation of a compound selected from the group consisting of imidazoles, pyrazoles, thiazoles, isothiazoles, azathiozoles, oxothiazoles, oxazines, oxazolines, oxazaboroles, dithiozoles, triazoles, selenozoles, oxaphospholes, pyrroles, boroles, furans, thiophens, phospholes, pentazoles, indoles, indolines, oxazoles, isoxazoles, isotriazoles, tetrazoles, benzofurans, dibenzofurans, benzothiophens, dibenzothiophens, thiadiazoles, pyridines, pyrimidines, pyrazines, pyridazines, piperazines, piperidines, morpholones, pyrans, annolines, phthalazines, quinazolines, quinolines, isoquinolines, thazines, oxazines, azaannulenes and quinoxalines.

27. An ionic liquid characterized by the general formula A⁺B⁻ where A⁺ represents any stable inorganic or organic cation and B⁻ represents any stable organic or inorganic anion; and wherein A⁺ can be characterized by the general formula: 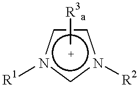
where R¹ and R² are independently selected from the group consisting of hydrogen, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; and
R³ is selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; and a is 0, 1, 2, or 3 signifying the number of R³ groups attached to a carbon atom of the ring.

28. An ionic liquid characterized by the general formula A⁺B⁻ where A⁺ represents any stable inorganic or organic cation and B⁻ represents any stable organic or inorganic anion; and wherein A⁺ can be characterized by the general formula: 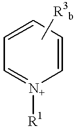
where R¹ is selected from the group consisting of hydrogen, substituted alkyl, cycloalkyl, substituted cycloalkyl, heteroalkyl, heterocycloalkyl, substituted heterocycloalkyl, aryl, substituted aryl, heteroaryl, substituted heteroaryl, acyl, alkoxy, aryloxy, silyl, boryl, phosphino, amino, thio, seleno, and combinations thereof; and
R³ is selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; and b is 0, 1, 2, 3, 4 or 5 signifying the number of R³ groups attached to a carbon atom of the ring.

29. An ionic liquid characterized by the general formula A⁺B⁻ where A⁺ represents any stable inorganic or organic cation and B⁻ represents any stable organic or inorganic anion; and wherein A⁺ can be characterized by the general formula: 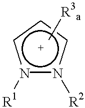
where R¹, R² and R³ are independently selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; and a is 0, 1, 2 or 3 signifying the number of R³ groups attached to a carbon atom of the ring.

30. An ionic liquid characterized by the general formula A⁺B⁻ where A⁺ represents any stable inorganic or organic cation and B⁻ represents any stable organic or inorganic anion; and wherein A⁺ can be characterized by the either of the general formulas: R¹R²R³R⁴N⁺ or R¹R²R³R⁴P⁺ where each of R¹, R², R³ and R⁴ is independently selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, silyl, boryl, phosphino, amino, thio, seleno, and combinations thereof.

31. An ionic liquid characterized by the general formula A⁺B⁻ where A⁺ represents any stable inorganic or organic cation and B⁻ represents any stable organic or inorganic anion; and wherein A⁺ is an acyclic organic compound capable of being converted into a stable organic cation, and the acyclic compound is selected from the group consisting of amines, phosphines, arsines, stibines, ethers, thioethers and selenoethers.

32. The ionic liquid of any of claims 24, 25, 26,27, 28, 29, 30 or 31 wherein B⁻ is represented by the general formula AlR_{4z}X_{z}⁻ where R is selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; X is selected from the group of halogens; and z is 0, 1, 2, 3 or 4.

33. The ionic liquid of any of claims 24, 25, 26, 27, 28, 29, 30 or 31 wherein B⁻ may be selected from the group consisting of halogens, BX₄⁻, PF₆⁻, AsF₆⁻, SbF₆⁻, NO₂⁻, NO₃⁻, SO₄²⁻, BR₄⁻, substituted or unsubstituted carboranes, substituted or unsubstituted metallocarboranes, phosphates, phosphites, polyoxometallates, substituted or unsubstituted carboxylates, noncoordinating anions and triflates; and wherein R is selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof.

34. An ionic liquid characterized by one of the general formulas Aⁿ⁺Bⁿ⁻, Aⁿ⁺nB⁻ or nA⁺Bⁿ⁻ where n is any positive integer greater than 1 and where Aⁿ⁺ or A⁺ represents any stable inorganic or organic cation and B⁻ or Bⁿ⁻ represents any stable organic or inorganic anion.

35. The ionic liquid of claim 34, wherein A⁺ may be represented by the following general formula: 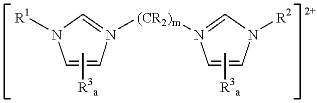
where n is 2; R, R¹, R² and R³ are independently selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; a is 0, 1, 2, or 3 signifying the number of R³ groups attached to a carbon atom of the ring; and m is an integer from 1-50.

36. The ionic liquid of claim 35, wherein the CR₂ is replaced with a compound selected from the group consisting of substituted alkyls and substituted aryls.

37. The ionic liquid of claim 35, additionally comprising a second ionic liquid characterized by the general formula A⁺B⁻ where A⁺ represents any stable inorganic or organic cation and B⁻ represents any stable organic or inorganic anion.

38. The ionic liquid of claim 35 additionally comprising a reagent to initiate cationic polymerization wherein said reagent is selected from the group consisting of BR_{3-y}X_{y}, AlR_{3-y}X_{y}, alkylaluminoxanes, GaR_{3-y}X_{y}, InR_{3-y}X_{y}, TiR_{4-z}X_{z}, In(triflate)₃, Ge[NR₂]₂, SnR_{4-z}X_{z}, VCl₃, VCl₄, VOCl₃, VOCl₂, Sc(triflate)₃, Yb[NR₂]₃, Ti(OPrⁱ)₄, CpTiMe₃, Cp₂TiR₂, Cp₂ZrR₂, Cp₂HfR₂, TiCl₃, ZrCl₃, HfCl₃, ZrCl₄, HfCl₄, Ti[(NR₂)_{4-z}R_{z}], Zr[(NR₂)_{4-z}R_{z}], Hf[(NR₂)_{4-z}R_{z}], Zr[(NR₂)_{4-z}X_{z}], Hf[(NR₂)_{4-z}X_{z}], Ti[(NR₂)_{4-z}X_{z}], La[NR₂]₂, Er[NR₂]₂, ThCl₄, ThOCl₂, UCl₄, UCl₅, Cp₃U, NbCl₅, TaCl₅, CrCl₂, Cr(TFA)₂, CrCl₃, Cr(TFA)₃, CrOCl₂, CrO₂Cl₂, CrO₃, Cp₂Cr, MoCl₃, MoCl₄, MoCl₅, WCl₃, WCl₄, FeCl₂, Fe(TFA)₂, FeCl₃, Fe(TFA)₃, Co(TFA)₂, Co(TFA)₃, Mn(TFA)₂, Ni(TFA)₂, Pd(TFA)₂, V(TFA)₃, V(TFA)₂, Cu(TFA), Ag(TFA), SbX₅, PX₅, PX₃, POX₃, Cp₂AIR, HX, RX, water, alcohols, triflic acids, substituted or unsubstituted carboxylic acids, acylium ions, substituted alkyls, substituted aryls, [Ph₃C][BR₄], [R₃NH][BR₄], [R₂OH][BR₄], [Ph₃C][BX₄], [Ph₃C][PF₆], [Ph₃C][SbF₆], [Ph₃C][AsF₆], NaBR₄, LiBR₄, KBR₄, AgBX₄, AgBR₄, AgPF₆, AgSbF₆, AgAsF₆, AgNO₃, PbBX₄, PbBR₄, PbPF₆, PbSbF₆, PbAsF₆, PbNO₃, TlBR₄, TlPF₆, TlBX₄, TlSbF₆, TlAsF₆, TlNO₃ and combinations thereof; where R is selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; y is a number 0, 1, 2 or 3; z is a number 0, 1, 2, 3 or 4; Cp is an unsubstituted or substituted cyclopentadienyl ring, substituted or unsubstituted indenyl, substituted or unsubstituted fluorenyl, including bridging versions thereof; and X is a halogen.

39. The ionic liquid of any of claims 24, 25, 26, 27, 28, 29, 30, 31 or 34 wherein the ionic liquid contains a group that can act as a catalyst or scavenger and said group is covalently bonded to either A⁺ or B⁻.

40. The ionic liquid of claim 39, wherein said group is attached directly to the cationic portion of the ionic liquid, so that A⁺ may represented by the following general formula: 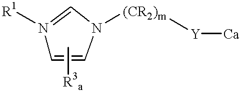
where each R, R¹ and R³ are independently selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, acyl, silyl, boryl, phosphino, amino, thio, seleno, and combinations thereof; a is 0, 1, 2, or 3 signifying the number of R³ groups attached to a carbon atom of the ring; m is an integer from 1-50; Y is any functional group capable of binding the catalyst or scavenger; and Ca is the catalyst or scavenger.

41. The ionic liquid of claim 39, wherein said group is covalently bonded to B⁻.

42. The ionic liquid of claim 39, wherein said ionic liquid may be characterized by the general formula: 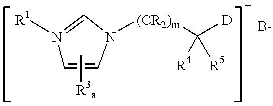
where R, R¹, R³, R⁴ and R⁵ are are independently selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted beteroaryl, alkoxy, aryloxy, acyl, silyl, boryl, phosphino, amino, thio, seleno, and combinations thereof; a is 0, 1, 2, or 3 signifying the number of R³ groups attached to a carbon atom of the ring; m is an integer from 1-50; and D is selected from the group consisting of halogen, SCN, CN, OH, OR, OCOR, COOR, O₂SR.

43. The ionic liquid of claim 39, additionally comprising a second ionic liquid characterized by the general formula A⁺B⁻ where A⁺ represents any stable inorganic or organic cation and B⁻ represents any stable organic or inorganic anion.
